(19) United States
(12) Patent Application Publication
(10) Pub. No.: US 2012/0183051 A1
(43) Pub. Date: Jul. 19, 2012

(54) METHOD FOR VIDEO ENCODING MODE SELECTION AND VIDEO ENCODING APPARATUS PERFORMING THE SAME

(75) Inventor: Yang ZHANG, Suwon-si (KR)

(73) Assignee: Samsung Electronics Co., Ltd., Suwon-si (KR)

(21) Appl. No.: 13/316,746

(22) Filed: Dec. 12, 2011

(30) Foreign Application Priority Data
Jan. 19, 2011 (KR) 10-2011-0005558

(51) Int. Cl. H04N 7/32

(52) U.S. Cl. 375/240.03; 375/E07.127

(57) ABSTRACT

A method for video encoding mode selection and a video encoding apparatus for performing the method are provided. The method includes transforming an original image block into the frequency domain for each of two or more encoding modes, quantizing the transformed image blocks, performing distortion estimation for encoded blocks corresponding to the encode modes on the basis of quantized indices of the quantized image blocks and quantization parameters, performing rate estimation for the encoded blocks corresponding to the encode modes on the basis of quantized indices of the quantized image blocks, and performing encoding mode selection using estimated block rate values and estimated block distortion values. Hence, a method is provided that enables suitable encoding modes to be selected through efficient and effective computation of rate-distortion costs. In addition, a video encoding apparatus is provided that can execute the method.

### PRIORITY

This application claims the benefit under 35 U.S.C. §119(a) of a Korean patent application filed on Jan. 19, 2011 in the Korean Intellectual Property Office and assigned Serial No. 10-2011-0005558, the entire disclosure of which is hereby incorporated by reference.

### BACKGROUND OF THE INVENTION

1. Field of the Invention

The present invention relates to video encoding mode selection. More particularly, the present invention relates to a method and apparatus that enables efficient selection of encoding modes suitable for specific video images.

2. Description of the Related Art

FIG. 1 illustrates a procedure for video distribution according to the related art.

Referring to FIG. 1, at the transmitter 100, original video 110 is compressed through video compression 120 into a compressed bit stream 130. The compressed bit stream 130 is sent to the receiver 150 through a channel 140. At the receiver 150, the received compressed bit stream 160 is decompressed through video decompression 170 into reconstructed video 180. A user may view the reconstructed video 180. As described above, video distribution may use compression (or encoding) and decompression (or decoding). While there are many video encoding methods, H.264/AVC has attracted much attention as an important standard.

For the video encoding standard H.264/AVC, various encoding (or coding) schemes have been proposed to increase encoding efficiency. The key to implementation of an efficient encoder is to define an appropriate cost measure for measuring rate-distortion performance. It is also important for encoder implementation to select suitable parameters on the basis of the cost measure. However, use of Rate-Distortion Optimization (RDO) causes a large increase in encoder complexity owing to motion estimation and mode determination. Lagrange multipliers are employed in RDO. RDO theory offers effective criteria for selecting optimal encoding modes for individual parts of an image, but requires high computational complexity due to transforms and entropy coding for distortion and bit rate computation.

In an implementation of the H.264/AVC Joint Model, two types of costs are defined. The low complexity cost takes only the motion related information into account, while the high complexity cost accounts for both bit rate and distortion for encoding both the motion and the still images. In particular, for bi-directional coded slices, use of the high-complexity cost may result in high encoding efficiency but computational burden may become a serious problem.

Computation of Rate-Distortion (RD) costs of individual modes for each block is a time consuming task. Hence, use of a good scheme for estimating coding bits and distortion in mode determination may enable retention of the advantages of RDO while significantly reducing complexity of the RDO operation.

### SUMMARY OF THE INVENTION

Aspects of the present invention are to address the above-mentioned problems and/or disadvantages and to provide at least the advantages described below. Accordingly, an aspect of the present invention is to provide a method that enables selection of suitable encoding modes through efficient computation of rate-distortion costs, and a video encoding apparatus capable of performing the method.

In accordance with an aspect of the present invention, a method of encoding mode selection for a video encoding apparatus is provided. The method includes transforming an original image block into the frequency domain for each of two or more encoding modes, quantizing the transformed image blocks, performing distortion estimation for encoded blocks corresponding to the encode modes on the basis of quantized indices of the quantized image blocks and quantization parameters, performing rate estimation for the encoded blocks corresponding to the encode modes on the basis of quantized indices of the quantized image blocks, and performing encoding mode selection using estimated block rate values and estimated block distortion values.

In accordance with an aspect of the present invention, an apparatus for video encoding is provided. The apparatus includes a transform unit for transforming an original image block into the frequency domain for each of two or more encoding modes, a quantization unit for quantizing the transformed image blocks, a distortion estimator for performing distortion estimation for encoded blocks corresponding to the encode modes on the basis of quantized indices of the quantized image blocks and quantization parameters, a rate estimator for performing rate estimation for the encoded blocks corresponding to the encode modes on the basis of quantized indices of the quantized image blocks, and a mode selector for performing encoding mode selection using estimated block rate values and estimated block distortion values.

In a feature of the present invention, a method is provided that enables suitable encoding modes to be selected through efficient and effective computation of rate-distortion costs. In addition, a video encoding apparatus is provided that can execute the method.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a procedure for video distribution according to the related art;

FIG. 2 illustrates encoding mode selection in a H.264/AVC standard according to the related art;

FIG. 3 illustrates a procedure for encoding mode selection according to the related art;

FIG. 4 illustrates a procedure for encoding mode selection according to an exemplary embodiment of the present invention;

FIG. 5 is a block diagram of a video encoding apparatus according to another exemplary embodiment of the present invention;

FIG. 6 is a flowchart of a video encoding procedure according to another exemplary embodiment of the present invention;

FIG. 7 is a flowchart of a distortion estimation step of the procedure in FIG. 6 according to an exemplary embodiment of the present invention;

FIG. 8 is a flowchart of a rate estimation step of the procedure in FIG. 6 according to an exemplary embodiment of the present invention; and

FIGS. 9 and 10 are graphs depicting results of rate and distortion estimation according to an exemplary embodiment of the present invention.

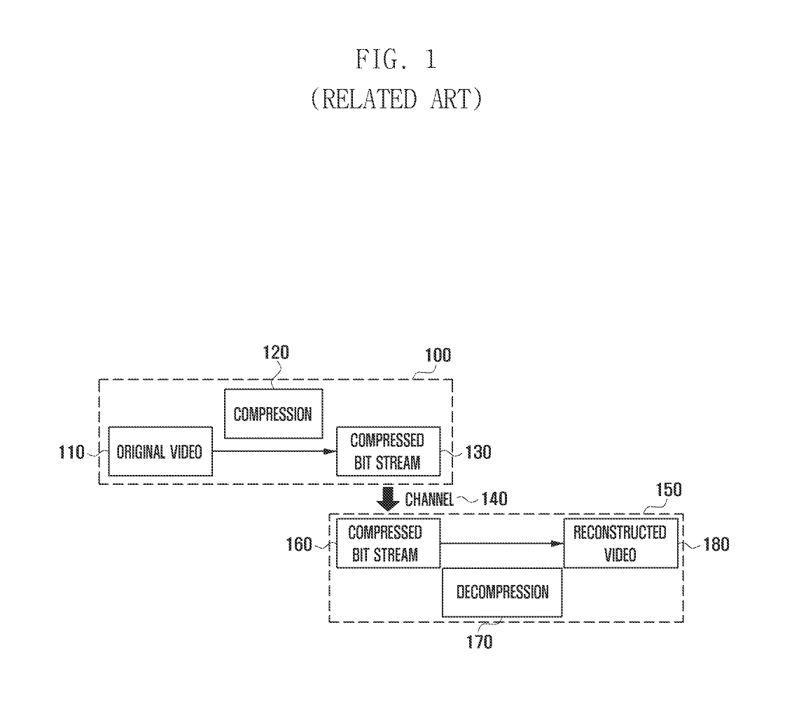

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A description will be given of a method for video encoding mode selection and a video encoding apparatus performing the same with reference to the drawings.

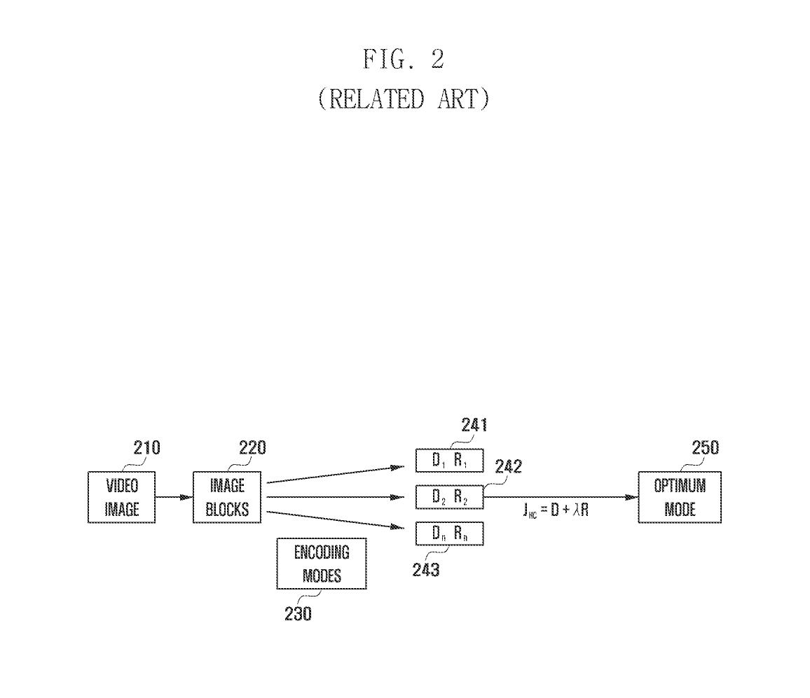

FIG. 2 illustrates encoding mode selection based on a H.264/AVC standard according to the related art.

Referring to FIG. 2, the video encoding apparatus divides a video image 210 into image blocks 220. For example, an image block 220 may be a block of 4×4 pixels. For each image block 220, the video encoding apparatus encodes the image block 220 using applicable encoding modes 230, measures the distortion and rate of each encoded image block (241, 242, 243), and selects one of the encoding modes 230 having a minimum J_{HC} (defined below) as an optimal mode 250 for the image block 220.

J_{HC}=D+λR Equation 1

where R denotes the bits needed to code the MacroBlock (MB) using the particular encoding mode (bit rate or bit cost), D denotes distortion of the encoded macroblock using the encoding mode, and λ is a coefficient depending upon Quantization Parameters (QP) for maintaining a balance between distortion and bit cost.

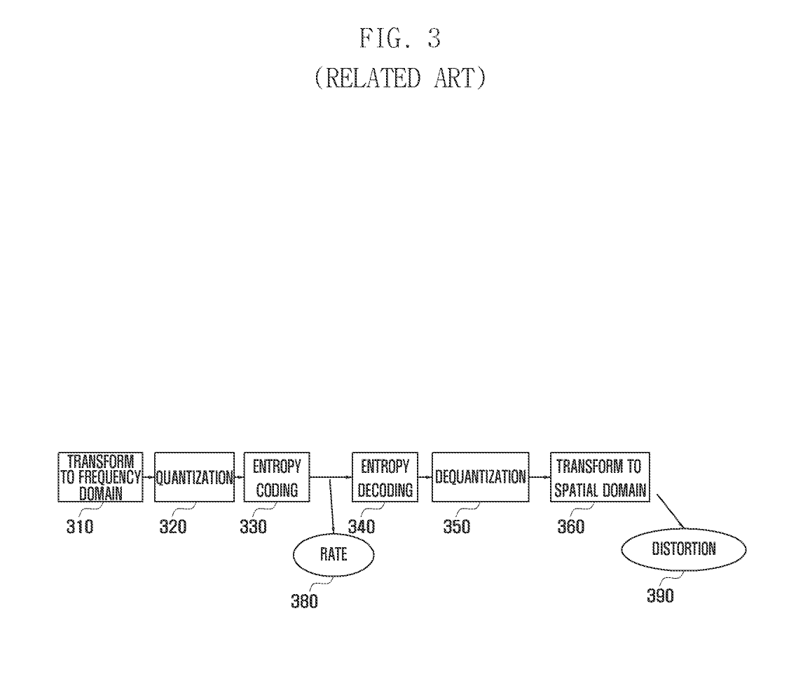

FIG. 3 illustrates a procedure for encoding mode selection according to the related art.

Referring to FIG. 3, the video encoding apparatus transforms an image block of a video image from the spatial domain into the frequency domain in step 310, quantizes the frequency domain image block in step 320, entropy-codes the quantized image block in step 330, and computes the rate value for the image block on the basis of the number of bits in the entropy-coded image block in step 380.

Thereafter, the video encoding apparatus entropy-decodes the entropy-coded image block in step 340, dequantizes the entropy-decoded image block in step 350, transforms the dequantized image block into the spatial domain in step 360, and computes the distortion value by comparing the original image block with the image block transformed back into the spatial domain in step 390. Hence, the video encoding apparatus may compute J_{HC} using the obtained rate value and distortion value.

In the related art procedure of FIG. 3, J_{HC} for an image block may be obtained only after performing steps 310 to 360 for each encoding mode. For an image block, mode determination is possible after performing encoding and decoding for all applicable encoding modes, which requires a long time.

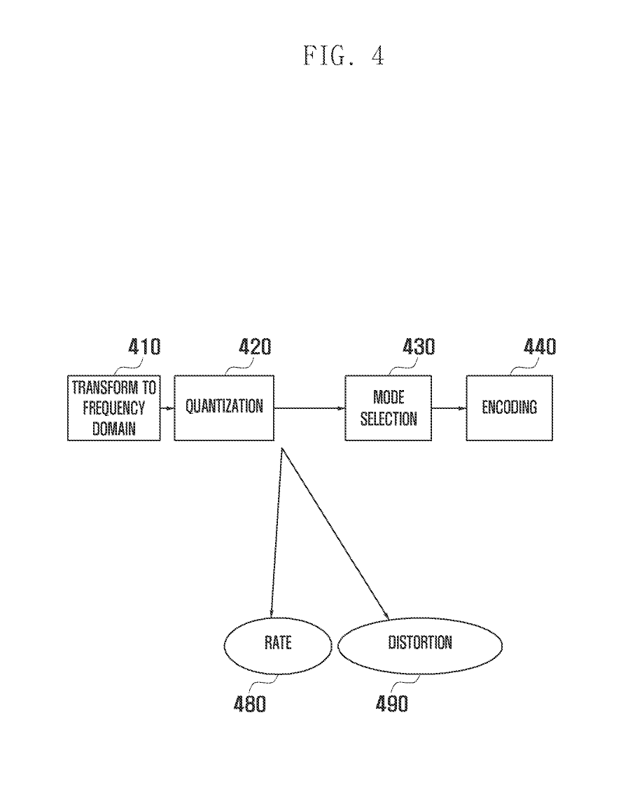

FIG. 4 illustrates a procedure for encoding mode selection according to an exemplary embodiment of the present invention.

Referring to FIG. 4, the video encoding apparatus transforms an image block of a video image from the spatial domain into the frequency domain in step 410 and quantizes the frequency domain image block in step 420. Unlike the case of FIG. 3, the video encoding apparatus does not perform entropy coding, entropy decoding, dequantization and spatial domain transformation. In the case of FIG. 4, the video encoding apparatus estimates the rate value and distortion value for each encoding mode on the basis of the quantized image block in steps 480 and 490. J_{HC} is computed using the estimated rate value and distortion value, leading to selection of the optimal or near optimal encoding mode at low cost in step 430. Thereafter, encoding is performed using the selected encoding mode in step 440.

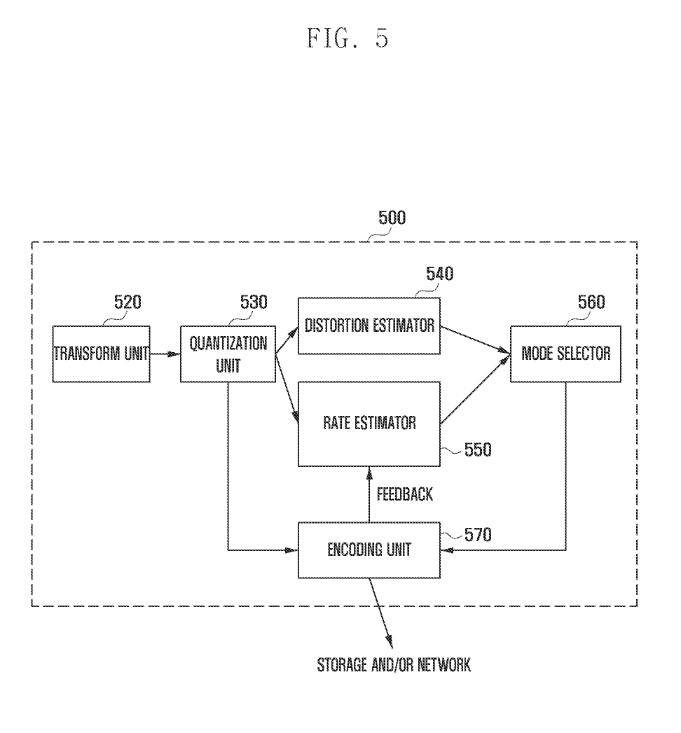

FIG. 5 is a block diagram of a video encoding apparatus according to another exemplary embodiment of the present invention.

Referring to FIG. 5, the video encoding apparatus 500 includes a transform unit 520, a quantization unit 530, a distortion estimator 540, a rate estimator 550, a mode selector 560, and an encoding unit 570.

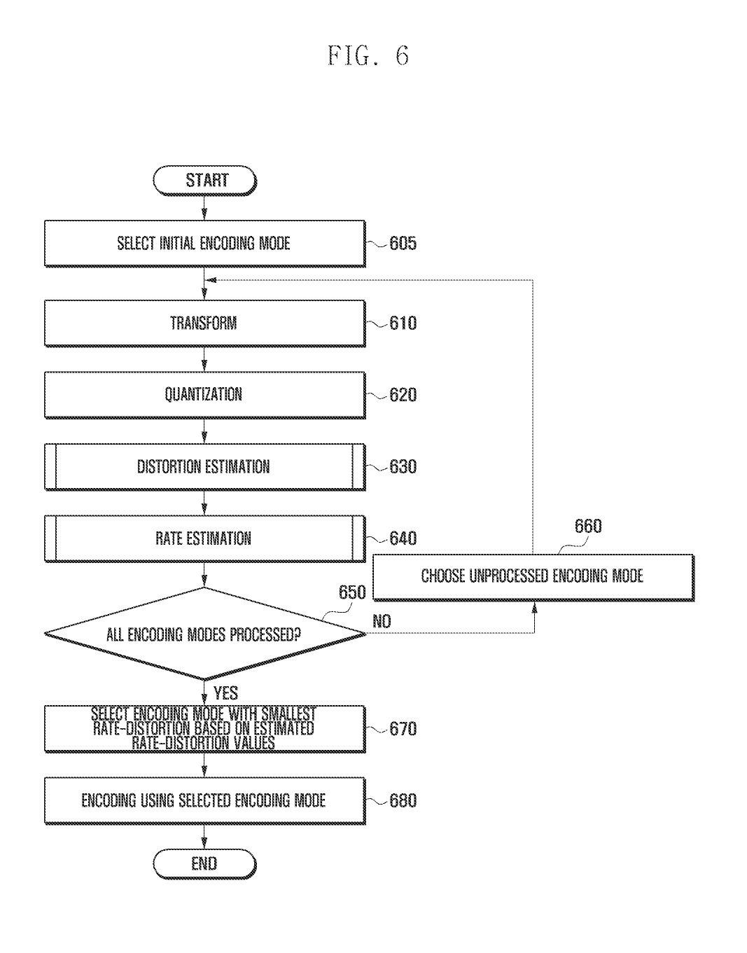

The transform unit 520 transforms an image block from the spatial domain into the frequency domain. Here, the image block is transformed using two or more applicable encoding modes. Quantization, distortion estimation, rate estimation and J_{HC} computation are performed for each encoding mode. Mode determination will be described further below with reference to FIG. 6.

The transform performed by the transform unit 520 may be an integer Discrete Cosine Transform (DCT) or other comparable transform. With evolution of the H.264 standard, different transforms may be utilized. Frequency domain transform of an image block is known to those skilled in the art, and a description thereof will thus be omitted. The transformed image block is forwarded to the quantization unit 530.

The quantization unit 530 quantizes the frequency domain image block. Quantization may be performed through multiplication of the image block by a suitable quantizing matrix or other similar operation. Quantization of an image block is known to those skilled in the art, and a description thereof will thus be omitted for conciseness in explanation.

The quantized image block is forwarded to the distortion estimator 540 and the rate estimator 550. When the corresponding encoding mode is selected, the quantized image block may be forwarded to the encoding unit 570.

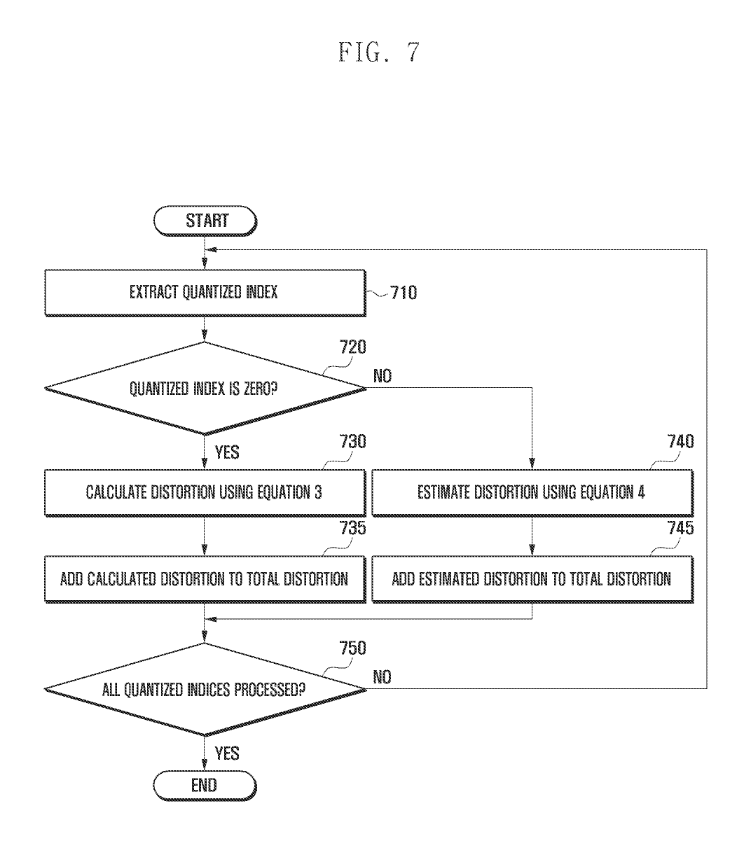

The distortion estimator 540 estimates, for each encoding mode, distortion of the encoded block using quantized indices forming the quantized image block and the quantization parameter determined by the encoding mode. Here, the encoded block indicates the finally encoded image block. Distortion estimation is described in detail further below in connection with FIG. 7. The estimated distortion value is forwarded to the mode selector 560 and used as a mode selection criterion.

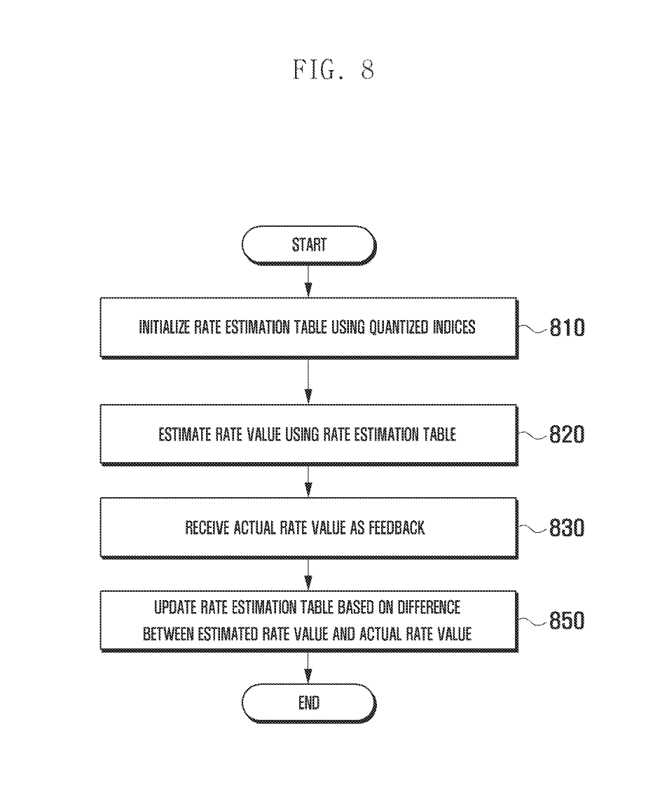

The rate estimator 550 estimates, for each encoding mode, the rate value of the encoded block using quantized indices. Rate estimation is described in detail further below with reference to FIG. 8. The estimated rate value is forwarded to the mode selector 560 and used as a mode selection criterion.

The mode selector 560 computes J_{HC} for each encoding mode using the distortion value estimated by the distortion estimator 540 and the rate value estimated by the rate estimator 550, and selects the optimal encoding mode on the basis of J_{HC} values. The selected encoding mode is forwarded to the encoding unit 570 and used as the actual encoding mode.

The encoding unit 570 encodes the original image block using the encoding mode selected by the mode selector 560. Here, the quantized image block corresponding to the selected encoding mode may be entropy-coded. The encoded image block may be saved in the form of a file or may be distributed in the form of a bit stream through a network.

FIG. 6 is a flowchart of a video encoding procedure according to another exemplary embodiment of the present invention.

Referring to FIG. 6, steps 610 to 640 are executed once for each encoding mode supported by the video encoding apparatus 500. For example, the encoding modes may be intra prediction modes supported by the video encoding apparatus 500. In H.264, nine intra prediction modes may be allowed for a 4×4 block. However, other prediction modes may be applied in the present invention.

The procedure begins with setting an initial encoding mode to be used for rate-distortion estimation in step 605. Here, any applicable encoding mode may be set as the initial encoding mode because all encoding modes are considered in steps 610 to 640.

The transform unit 520 transforms an image block from the spatial domain into the frequency domain according to the current encoding mode set for rate-distortion estimation in step 610. The transform performed by the transform unit 520 may be integer DCT or other comparable transform. With evolution of the H.264 standard, different transforms may be utilized. Frequency domain transform of an image block is known to those skilled in the art, and thus a description thereof is omitted for conciseness in explanation. The transformed image block is forwarded to the quantization unit 530.

The quantization unit 530 quantizes the frequency domain image block in step 620. Quantization may be performed through multiplication of the image block by a suitable quantizing matrix or other similar operation. Quantization of an image block is known to those skilled in the art, and thus a description thereof is omitted for conciseness in explanation. The quantized image block is forwarded to the distortion estimator 540 and the rate estimator 550.

The distortion estimator 540 estimates distortion of the encoded block using quantized indices forming the quantized image block and the quantization parameter determined by the current encoding mode in step 630. Distortion estimation is described further below with reference to FIG. 7. The estimated distortion value is forwarded to the mode selector 560 and used as a mode selection criterion.

The rate estimator 550 estimates the rate value of the encoded block using quantized indices for the current encoding mode in step 640. Rate estimation is described further below with reference to FIG. 8. The estimated rate value is forwarded to the mode selector 560 and used as a mode selection criterion.

The video encoding apparatus 500 determines whether all encoding modes have been processed for rate-distortion estimation in step 650. When all encoding modes have not been processed, the video encoding apparatus 500 sets the current encoding mode to an unused encoding mode in step 660 and returns to step 610. When all encoding modes have been processed, the video encoding apparatus 500 proceeds to step 670.

The mode selector 560 computes estimated J_{HC} (according to Equation 2) for each encoding mode using estimated distortion values and estimated rate values, and selects the optimal encoding mode on the basis of estimated J_{HC} values in step 670.

estimated J_{HC}=(estimated distortion)+λ(estimated rate) Equation 2

Unlike Equation 1, the distortion value and rate value estimated according to an exemplary embodiment of the present invention are used in Equation 2.

The mode selector 560 may select the encoding mode that yields the smallest estimated J_{HC} value.

The encoding unit 570 performs encoding using the selected encoding mode in step 680. Here, the quantized image block corresponding to the selected encoding mode may be entropy-coded.

The procedure of FIG. 6 is described as sequentially performing rate and distortion estimation for each encoding mode. When the video encoding apparatus 500 is a multi-core device, rate and distortion estimation for individual encoding modes may be performed concurrently or at the same time. For the same encoding mode, step 630 of distortion estimation and step 640 of rate estimation may be performed concurrently.

FIG. 7 is a flowchart of a distortion estimation step (step 630) of the procedure in FIG. 6 according to an exemplary embodiment of the present invention. As described above, step 630 of distortion estimation is executed for each encoding mode applicable to a given image block.

In H.264/AVC, transforms between the spatial domain and the frequency domain are orthogonal. Hence, distortion of an encoded image may be estimated in the frequency domain using a suitable scaling operation. For a frequency pair (i, j), a transform coefficient C(i, j) is quantized into a quantized index C_{q}(i, j) using a quantization parameter (QP).

Referring to FIG. 7, the distortion estimator 540 extracts a quantized index of a quantized image block in step 710. The distortion estimator 540 receives a quantized image block composed of quantized indices from the quantization unit 530.

The distortion estimator 540 determines whether the extracted quantized index is equal to zero in step 720. When the quantized index is equal to zero, the distortion estimator 540 performs distortion computation using Equation 3 in step 730. When a quantized index is zero, distortion D(i, j) for a frequency pair (i, j) is calculated using Equation 3.

D(i,j)=C²(i,j)/W(i,j) Equation 3

where W(i,j) is a transform gain at the frequency pair. Transform gain may be derived from the transform matrix. Derivation of transform gain is known to those skilled in the art, and thus a description thereof is omitted for conciseness in explanation.

The distortion estimator 540 adds the computed distortion value to the total distortion in step 735.

When the quantized index is not equal to zero, the distortion estimator 540 performs distortion estimation using Equation 4 in step 740. When a quantized index is non-zero, calculation of distortion D(i, j) for a frequency pair (i, j) may be complex. However, for approximate distortion estimation, results of the quantization theory may be utilized. As known in the art, when the probability distribution of a signal is smooth and the quantization step size is sufficiently small, quantization distortion may be approximately estimated using Equation 4.

D′(i,j)=Δ²/12 Equation 4

where D′(i, j) indicates the estimated value of distortion D(i, j) at a frequency pair (i, j) and Δ is the quantization step size corresponding to the quantization parameter. Derivation of the quantization step size corresponding to a quantization parameter is known in the art, and thus a description thereof is omitted for conciseness in explanation.

The distortion estimator 540 adds the estimated distortion value to the total distortion in step 745.

The distortion estimator 540 checks whether all quantized indices of the quantized image block have been processed for distortion estimation in step 750. When not all quantized indices have been processed, the distortion estimator 540 returns to step 710 and processes a new quantized index. When all the quantized indices have been processed, the total distortion indicates the estimated distortion value for the quantized image block. The procedure of FIG. 7 for estimating the distortion of a quantized image block may be represented by Equation 5.

$$D = {\sum }_{( i , j \vert {C}_{q} ( i , j ) = 0 )} {C}^{2} ( i , j ) / W ( i , j ) + {\sum }_{( i , j \vert {C}_{q} ( i , j ) \neq 0 )} {Δ}^{2} / 12 \qquad Equation 5$$

Quantization theory may be applicable when the quantization step size is small. However, approximate estimation may be accurate for a wide range of quantization parameters. When the quantization parameter is large, most transform coefficients are mapped through quantization to quantized indices of zero. As described before in connection with Equation 3 and Equation 5, when a quantized index is zero, the distortion value can be accurately calculated. Hence, the adverse effect of quantization mismatch may be compensated for. In addition, transform coefficients may be modeled using a Laplace distribution. This indicates that the probability density of transform coefficients having non-zero quantized indices is quite low.

The estimated distortion value is forwarded to the mode selector 560 and used as a mode selection criterion.

FIG. 8 is a flowchart of a rate estimation step (step 640) of the procedure in FIG. 6 according to an exemplary embodiment of the present invention.

The rate value may be estimated with reference to a rate estimation table. This enables tracking of encoding parameters and adaptive rate estimation according to encoding parameters and video contents.

Referring to FIG. 8, the rate estimator 550 initializes the rate estimation table using quantized indices in step 810. Quantized indices are described in relation to FIG. 7. The rate estimator 550 may maintain a rate estimation table to perform rate estimation.

The rate estimation table stores a value map of a function f(TC, TZ).

The rate estimation table is initialized using Equation 6.

fᵢ(TC,TZ)=3×TC+TZ+SAD Equation 6

where TC indicates the number of non-zero quantized indices of the quantized image block, TZ indicates the sum of run values in the quantized image block and SAD (Sum of Absolute Differences) indicates the sum of quantized indices of the quantized image block.

The rate estimator 550 estimates the rate value of the quantized image block using the rate estimation table in step 820. Here, Equation 7 is used for rate estimation.

Rₑ=SAD+f(TC,TZ) Equation 7

As described above, f(TC, TZ) may be evaluated using the value map stored in the rate estimation table.

The rate estimator 550 receives an actual rate value as feedback in step 830. When the rate estimator 550 forwards the estimated rate value to the mode selector 560, the mode selector 560 determines the encoding mode using the estimated rate value and the encoding unit 570 completes entropy coding according to the determined encoding mode. After entropy coding, the actual rate value of the encoded image block may be obtained and delivered to the rate estimator 550.

The rate estimator 550 updates the rate estimation table using the difference between the estimated rate value and the actual rate value according to a low pass filtering rule in step 850.

f(TC,TZ)=ε[R−SAD−f(TC,TZ)] Equation 8

where ε is a forgetting factor and R is the actual rate value.

When Context-Adaptive Binary Arithmetic Coding (CABAC) is employed for entropy coding, video sequences may be used to train the rate estimation table. For a 4×4 block, as 0≦TC≦16 and 0≦TZ≦16-TC, 136 (i.e., 17(17+1)/2) table slots are necessary. Such space may be available for actual implementation.

The rate value for encoding motion related information may be estimated using exponential Golomb codes.

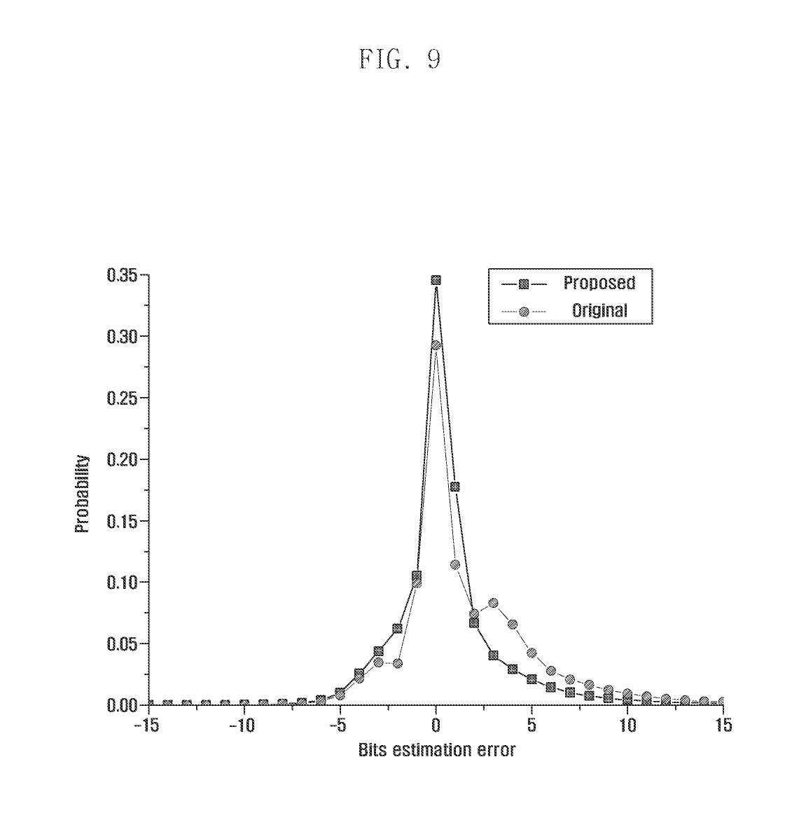

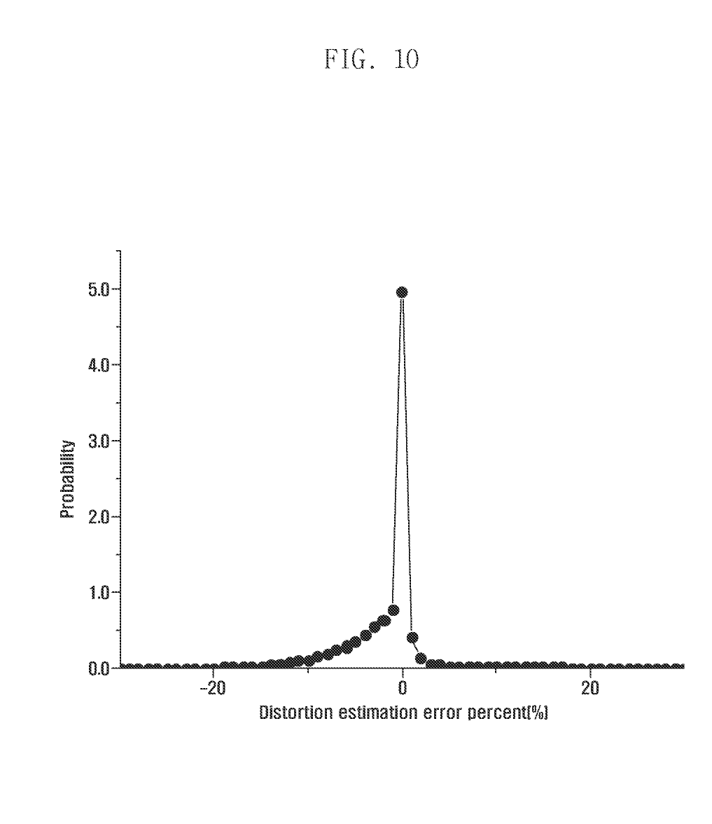

FIGS. 9 and 10 are graphs depicting results of rate and distortion estimation according to an exemplary embodiment of the present invention. FIGS. 9 and 10 indicate that the method of an exemplary embodiment of the present invention does not result in a significant increase in errors in comparison to a method of the related art.

Reference software JM 10.1 was used as an experimental platform.

Table 1 illustrates three categories of coding parameters used in the experiment.

TABLE 1

| | | Entropy | Transform |
|---|---|---|---|
| Category | QP range | coding | size |
| 1 | 24, 28, 32, 36 | CAVLC | 4 × 4 |
| 2 | 24, 28, 32, 36 | CABAC | 4 × 4 |
| 3 | 20, 24, 28, 32 | CAVLC | 4 × 4 & 8 × 8 |

Results of the experiment are summarized in Table 2 to Table 4.

TABLE 2

| | |
|---|---|
| RDO vs. | RDO vs. |
| Fast RDO | RDO off |

| | Rate | | Rate | | MD time |
|---|---|---|---|---|---|
| CAVLC | Dec. | Gain | Dec. | Gain | decrease |
| encoding | (%) | (dB) | (%) | (dB) | (%) |
| Foreman.qcf | 0.96 | 0.051 | 4.99 | 0.21 | 35.4 |
| Silent.qcf | 0.70 | 0.039 | 6.39 | 0.36 | 30.8 |
| Paris.cif | 0.61 | 0.044 | 5.69 | 0.30 | 33.2 |
| Tempete.cif | 1.33 | 0.057 | 10.82 | 0.42 | 41.3 |
| Coastguard.cif | 0.42 | 0.011 | 8.11 | 0.34 | 39.5 |
| Mobile.cif | 1.48 | 0.067 | 9.49 | 0.41 | 42.7 |
| Average | 0.92 | 0.045 | 7.58 | 0.34 | 37.2 |

TABLE 3

| | |
|---|---|
| RDO vs. | RDO vs. |
| Fast RDO | RDO off |

| | Rate | | Rate | | MD time |
|---|---|---|---|---|---|
| CABAC | Dec. | Gain | Dec. | Gain | decrease |
| encoding | (%) | (dB) | (%) | (dB) | (%) |
| Foreman.qcf | 1.81 | 0.085 | 4.30 | 0.182 | 43.6 |
| Silent.qcf | 1.12 | 0.067 | 5.22 | 0.296 | 41.3 |
| Paris.cif | 1.41 | 0.082 | 3.55 | 0.183 | 41.7 |
| Tempete.cif | 1.59 | 0.068 | 9.60 | 0.349 | 46.9 |
| Coastguard.cif | 0.36 | 0.017 | 7.02 | 0.289 | 48.9 |
| Mobile.cif | 1.69 | 0.077 | 7.78 | 0.315 | 49.0 |
| Average | 1.33 | 0.066 | 6.25 | 0.269 | 45.23 |

TABLE 4

| CAVLC | RDO vs. | | RDO vs. | | |
|---|---|---|---|---|---|
| encoding with | Fast RDO | | RDO off | | MD time |
| transform size | Rate | Gain | Rate | Gain | decrease |
| selection | Dec. (%) | (dB) | Dec. (%) | (dB) | (%) |
| Tempete.cif | 1.63 | 0.084 | 11.58 | 0.53 | 65.2 |
| Coastguard.cif | 0.89 | 0.043 | 13.22 | 0.65 | 63.9 |
| Mobile.cif | 1.59 | 0.083 | 10.52 | 0.52 | 63.9 |
| Average | 1.37 | 0.070 | 11.77 | 0.57 | 64.3 |

The GOP format of Foreman, Silent and Paris is IPPP, and the GOP format of Mobile, Coastguard and Tempete is IPBP. “MD time decrease” indicates reduction in mode determination time for RDO computation based on a related art scheme and computation based on the scheme of the present invention. In inter slices, rate-distortion computation for intra modes takes considerable time with little performance enhancement, and the RDO option is turned off for accurate computation. Experiment results show that utilizing CAVLC according to an exemplary embodiment of the present invention achieves most of performance enhancement attainable by RDO. Average increase in the number of bits (rate) is 0.92 percent. This corresponds to an average PSNR loss of 0.045 dB. When CABAC is utilized, performance degrades somewhat owing to a mismatch of rate estimation. However, as the mode determination time is reduced by more than 40 percent, such performance degradation may be tolerable. In addition, the results show that the scheme of the exemplary embodiment of the present invention is applicable together with optimum transform size determination.

As described above, the estimation scheme of the exemplary embodiment of the present invention provides sufficient accuracy in mode and transform size determination for practical use, leading to effective implementation of rate-distortion optimization.

It is known to those skilled in the art that blocks of a flowchart and a combination of flowcharts may be represented and executed by computer program instructions. These computer program instructions may be loaded on a processor of a general purpose computer, a special computer or programmable data processing equipment. When the loaded program instructions are executed by the processor, they create a means for carrying out functions described in the flowchart. As the computer program instructions may be stored in a computer readable memory that is usable in a specialized computer or a programmable data processing equipment, it is also possible to create articles of manufacture that carry out functions described in the flowchart. As the computer program instructions may be loaded on a computer or a programmable data processing equipment, when executed as processes, they may carry out steps of functions described in the flowchart.

A block of a flowchart may correspond to a module, a segment or a code containing one or more executable instructions implementing one or more logical functions, or to a part thereof. In some cases, functions described by blocks may be executed in an order different from the listed order. For example, two blocks listed in sequence may be executed at the same time or executed in reverse order.

In the present invention, the term “unit”, “module” or the like may refer to a software component or hardware component such as a Field-Programmable Gate Array (FPGA) or Application-Specific Integrated Circuit (ASIC) capable of carrying out a function or an operation. However, the term “unit” or the like is not limited to hardware or software. A unit or the like may be configured so as to reside in an addressable storage medium or to drive one or more processors. Units or the like may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose large components and units. Components and units may be configured to drive a device or one or more processors in a secure multimedia card.

Particular terms may be defined to describe the invention for ease in description. Accordingly, the meaning of specific terms or words used in the specification and the claims should not be limited to the literal or commonly employed sense, but should be construed in accordance with the spirit of the invention.

While the invention has been shown and described with reference to certain exemplary embodiments thereof, it will be understood by those skilled in the art that various changes in form and details may be made therein without departing the spirit and scope of the invention as defined in the appended claims and their equivalents.

What is claimed is:

1. A method of encoding mode selection for a video encoding apparatus, the method comprising:
transforming an original image block into the frequency domain for each of two or more encoding modes;
quantizing the transformed image blocks;
performing distortion estimation for encoded blocks corresponding to the encode modes on the basis of quantized indices of the quantized image blocks and quantization parameters;
performing rate estimation for the encoded blocks corresponding to the encode modes on the basis of quantized indices of the quantized image blocks; and
performing encoding mode selection using estimated block rate values and estimated block distortion values.

2. The method of claim 1, wherein the performing of the distortion estimation comprises:
calculating first distortion values for quantized indices of zero in a quantized image block associated with an encoding mode;
calculating approximate second distortion values for quantized indices of non-zero in the quantized image block; and
estimating a block distortion value for an encoded block corresponding to the encoding mode using the first and second distortion values.

3. The method of claim 2, wherein the performing of the distortion estimation comprises estimating a block distortion value for the encoded block corresponding to the encoding mode on the basis of the following equation:
$$D = {\sum }_{( i , j \vert {C}_{q} ( i , j ) = 0 )} {C}^{2} ( i , j ) / W ( i , j ) + {\sum }_{( i , j \vert {C}_{q} ( i , j ) \neq 0 )} {Δ}^{2} / 12 ,$$
wherein Δ indicates a quantization step size corresponding to the quantization parameter, W(i,j) indicates a transform gain at the frequency pair (i, j), C(i, j) indicates a transform coefficient, C_{q}(i, j) indicates a quantized index and D indicates an estimated block distortion value for the encoded block.

4. The method of claim 1, wherein the performing of the rate estimation comprises:
initializing a rate estimation table using quantized indices in a quantized image block associated with an encoding mode; and
estimating a block rate value for an encoded block corresponding to the encoding mode using the rate estimation table.

5. The method of claim 4, wherein the performing of the rate estimation further comprises:
receiving an actual block rate value for the encoded block as feedback; and
updating the rate estimation table on the basis of a difference between the actual block rate value and the estimated block rate value.

6. The method of claim 4, wherein the performing of the rate estimation comprises initializing the rate estimation table on the basis of the following equation:
fᵢ(TC,TZ)=3×TC+TZ+SAD,
wherein fᵢ(TC, TZ) indicates an initial value, TC indicates the number of quantized indices of non-zero in the quantized image block, TZ indicates the sum of run values in the quantized image block and SAD (Sum of Absolute Differences) indicates the sum of quantized indices in the quantized image block.

7. The method of claim 6, wherein the performing of the rate estimation comprises estimating a block rate value for the encoded block corresponding to the encoding mode on the basis of the following equation:
Rₑ=SAD+f(TC,TZ),
wherein Rₑ indicates an estimated block rate value for the encoded block and f(TC, TZ) indicates a value stored in the rate estimation table.

8. The method of claim 7, wherein the performing of the rate estimation comprises receiving an actual block rate value R and updating the rate estimation table on the basis of the following equation:
f(TC,TZ)=ε[R−SAD−f(TC,TZ)],
wherein ε is a forgetting factor.

9. The method of claim 1, further comprising:
encoding the original image block using the selected encoding mode.

10. The method of claim 1, wherein the performing of the encoding mode selection comprises selecting one of the encoding modes yielding the smallest estimated J_{HC} value defined by the following equation:
estimated J_{HC}=(estimated block distortion)+λ(estimated block rate),
wherein λ is a coefficient depending upon the quantization parameter.

11. An apparatus for video encoding, the apparatus comprising:
a transform unit for transforming an original image block into the frequency domain for each of two or more encoding modes;
a quantization unit for quantizing the transformed image blocks;
a distortion estimator for performing distortion estimation for encoded blocks corresponding to the encode modes on the basis of quantized indices of the quantized image blocks and quantization parameters;
a rate estimator for performing rate estimation for the encoded blocks corresponding to the encode modes on the basis of quantized indices of the quantized image blocks; and
a mode selector for performing encoding mode selection using estimated block rate values and estimated block distortion values.

12. The apparatus of claim 11, wherein the distortion estimator calculates first distortion values for quantized indices of zero in a quantized image block associated with an encoding mode, calculates approximate second distortion values for quantized indices of non-zero in the quantized image block, and estimates a block distortion value for an encoded block corresponding to the encoding mode using the first and second distortion values.

13. The apparatus of claim 12, wherein the distortion estimator estimates a block distortion value for the encoded block corresponding to the encoding mode on the basis of the following equation:
$$D = {\sum }_{( i , j \vert {C}_{q} ( i , j ) = 0 )} {C}^{2} ( i , j ) / W ( i , j ) + {\sum }_{( i , j \vert {C}_{q} ( i , j ) \neq 0 )} {Δ}^{2} / 12$$
wherein Δ indicates a quantization step size corresponding to the quantization parameter, W(i,j) indicates a transform gain at the frequency pair (i, j), C(i, j) indicates a transform coefficient, C_{q}(i, j) indicates a quantized index and D indicates an estimated block distortion value for the encoded block.

14. The apparatus of claim 12, wherein the rate estimator initializes a rate estimation table using quantized indices in a quantized image block associated with an encoding mode, and estimates a block rate value for an encoded block corresponding to the encoding mode using the rate estimation table.

15. The apparatus of claim 14, wherein the rate estimator receives an actual block rate value for the encoded block as feedback and updates the rate estimation table on the basis of a difference between the actual block rate value and the estimated block rate value.

16. The apparatus of claim 14, wherein the rate estimator initializes the rate estimation table on the basis of the following equation:
fᵢ(TC,TZ)=3×TC+TZ+SAD,
wherein fᵢ(TC, TZ) indicates an initial value, TC indicates the number of quantized indices of non-zero in the quantized image block, TZ indicates the sum of run values in the quantized image block and SAD (Sum of Absolute Differences) indicates the sum of quantized indices in the quantized image block.

17. The apparatus of claim 16, wherein the rate estimator estimates a block rate value for the encoded block corresponding to the encoding mode on the basis of the following equation:
Rₑ=SAD+f(TC,TZ),
wherein Rₑ indicates an estimated block rate value for the encoded block and f(TC, TZ) indicates a value stored in the rate estimation table.

18. The apparatus of claim 17, wherein the rate estimator receives an actual block rate value R and updates the rate estimation table on the basis of the following equation:
f(TC,TZ)=ε[R−SAD−f(TC,TZ)],
wherein ε is a forgetting factor.

19. The apparatus of claim 11, further comprising an encoding unit encoding the original image block using the selected encoding mode.

20. The apparatus of claim 11, wherein the mode selector selects one of the encoding modes yielding the smallest estimated J_{HC} value defined by the following equation:
estimated J_{HC}=(estimated block distortion)+λ(estimated block rate),
wherein λ is a coefficient depending upon the quantization parameter.
